(19) United States
(12) Patent Application Publication
(10) Pub. No.: US 2026/0174143 A1
(43) Pub. Date: Jun. 25, 2026

(54) AEROSOL-GENERATING DEVICE

(71) Applicant: KT&G CORPORATION, Daejeon (KR)

(72) Inventors: Dongsung KIM, Daejeon (KR); Junyeop OH, Daejeon (KR); Hwanhee JEONG, Daejeon (KR); Youngbum KWON, Daejeon (KR); Yonghwan KIM, Daejeon (KR); Hwikyeong AN, Daejeon (KR)

(73) Assignee: KT&G CORPORATION, Daejeon (KR)

(21) Appl. No.: 19/332,493

(22) Filed: Sep. 18, 2025

(30) Foreign Application Priority Data
Dec. 24, 2024 (KR) 10-2024-0196216

(51) Int. Cl. A24F 40/46; A24F 40/51

(52) U.S. Cl. CPC A24F 40/46; A24F 40/51

(57) ABSTRACT

An aerosol-generating device for generating an aerosol by heating an aerosol-generating article includes a first heater configured to generate heat inside the aerosol-generating article, a second heater configured to generate heat outside the aerosol-generating article, and a sensor configured to detect the aerosol-generating article and generate a signal, the sensor being placed to correspond to the first heater in a different area from an area where the second heater is placed outside the aerosol-generating article.

### CROSS-REFERENCE TO RELATED APPLICATION

This application is based on and claims priority under 35 U.S.C. § 119 to Korean Patent Application No. 10-2024-0196216, filed on Dec. 24, 2024, in the Korean Intellectual Property Office, the disclosure of which is incorporated by reference herein in its entirety.

### BACKGROUND

### 1. Field

Embodiments relate to an aerosol-generating device, and more particularly, to an aerosol-generating device capable of effectively heating a plurality of zones of an aerosol-generating article.

### 2. Description of the Related Art

Recently, there has been an increasing demand for an alternative method of overcoming the disadvantages of normal cigarettes. For example, there is an increasing demand for a system for generating aerosols by heating an aerosol generating substrate by using an aerosol generating device, rather than by burning cigarettes.

Aerosol-generating articles include multiple zones to perform functions, such as generating aerosols, imparting flavor, and providing functional ingredients. In order for an aerosol-generating device to generate high-quality aerosols from an aerosol-generating article, the aerosol-generating article has to be uniformly heated. Furthermore, in order for each zone of the aerosol-generating article to perform its function, each zone of the aerosol-generating article needs to be heated to an appropriate temperature.

### SUMMARY

Embodiments provide an aerosol-generating device capable of uniformly heating an aerosol-generating article.

Embodiments also provide an aerosol-generating device capable of heating each zone of an aerosol-generating article to an appropriate temperature.

Embodiments also provide an aerosol-generating device with improved sensor precision and durability.

Technical goals to be achieved through embodiments are not limited thereto, and technical goals unmentioned above would be clearly understood to those skilled in the art based on the present specification and the accompanying drawings.

Additional aspects will be set forth in part in the description which follows and, in part, will be apparent from the description, or may be learned by practice of the presented embodiments of the disclosure.

An aerosol-generating device according to an aspect, which is an aerosol-generating device for generating an aerosol by heating an aerosol-generating article, includes a first heater configured to generate heat inside the aerosol-generating article, a second heater configured to generate heat outside the aerosol-generating article, and a sensor configured to detect the aerosol-generating article and generate a signal, the sensor being placed to correspond to the first heater in a different area from an area where the second heater is placed outside the aerosol-generating article.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol-generating device according to an embodiment;

FIG. 2 illustrates an aerosol-generating device according to an embodiment;

FIG. 3 is a cross-sectional view of an aerosol-generating device according to another embodiment;

FIG. 4 is an exploded perspective view illustrating some elements of the aerosol-generating device according to the embodiment illustrated in FIG. 3;

FIG. 5 is a view for explaining an aerosol-generating device according to another embodiment;

FIG. 6 is a view for explaining an aerosol-generating device according to another embodiment;

FIG. 7 is a view for explaining an aerosol-generating device according to another embodiment;

FIG. 8 is a view for explaining an aerosol-generating device according to another embodiment;

FIG. 9 is a view illustrating a state in which another type of aerosol-generating article is inserted into the aerosol-generating device illustrated in FIG. 8; and

FIG. 10 is a flowchart illustrating an operation of the aerosol-generating device according to the embodiments illustrated in FIGS. 1 to 9.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory 17) readable by a machine (e.g., an aerosol generating device 1). For example, a processor (e.g., a controller 12) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The X-axis direction in the orthogonal coordinate system may be defined as a left-right direction of the aerosol generating device 1. The Y-axis direction may be defined as a front-back direction of the aerosol generating device 1. The Z-axis direction may be defined as an upward and downward direction of the aerosol generating device 1.

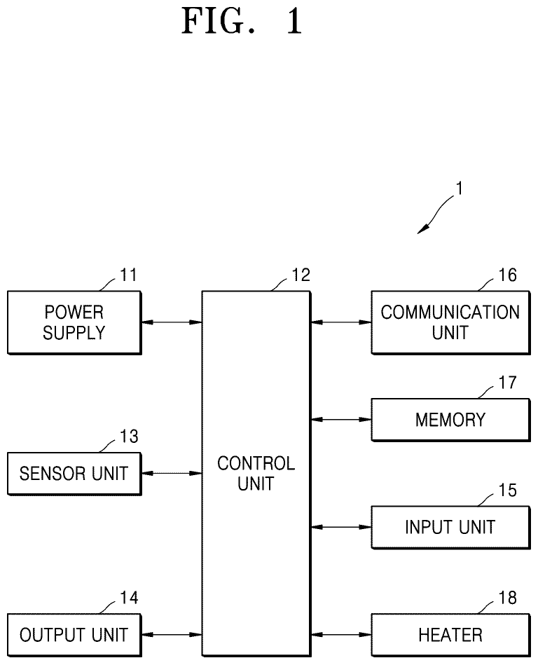

FIG. 1 is a block diagram of the aerosol generating device 1 according to an embodiment.

According to an embodiment, the aerosol generating device 1 may include a power supply 11, the controller 12, a sensor unit 13, an output unit 14, an input unit 15, a communication unit 16, a memory 17, and/or heater 18. However, it may be understood by those skilled in the art that some of the components shown in FIG. 1 may be omitted or new components may be added, according to the design of the aerosol generating device 1.

According to an embodiment, the sensor unit 13 may sense a state of the aerosol generating device 1 or a state of the surroundings of the aerosol generating device 1 and may transmit information corresponding to the sensed state to the controller 12. For example, the sensor unit 13 may include a temperature sensor, a puff sensor, an insertion detection sensor, a reuse detection sensor, an overwetting detection sensor, a cigarette identification sensor, a cartridge detection sensor, a cap detection sensor, and/or a movement detection sensor. The sensor unit 13 may further include various sensors, such as a liquid remaining amount sensor for detecting the liquid remaining amount of a cartridge and an immersion sensor for detecting immersion of the aerosol generating device 1.

According to an embodiment, the temperature sensor may detect the heating temperature of the heater 18 The aerosol generating device 1 may include a separate temperature sensor for detecting respective temperatures of the heater 18, or the heater 18 may serve as a temperature sensor. For example, the temperature sensor may be used to measure an impedance of the heater 18. The impedance of the heater 18 may be correlated with the temperature of the heater 18. The temperature sensor may measure a current and/or voltage applied to the heater 18 (or an induction coil). Based on the measured current and/or voltage, the impedance for the heater 18 may be calculated. The controller 12 may estimate the temperature of the heater 18, based on the calculated impedance.

For example, the temperature sensor may include a resistive element (e.g., a thermistor) whose resistance value changes in response to a change in temperatures of the heater 18. The temperature sensor may output a signal corresponding to the resistance value of the resistive element, and the controller 12 may detect the temperatures and/or temperature changes of the heater 18, based on the signal corresponding to the resistance value.

As another example, the temperature sensor may include a sensor for detecting the resistance values of the heater 18. The temperature sensor may output signals corresponding to the resistance values of the heater 18, and the controller 12 may detect the temperatures and/or temperature changes of the heater 18, based on the signals corresponding to the resistance values.

According to an embodiment, the temperature sensor may detect a temperature of the power supply 11. The temperature sensor may be disposed adjacent to the power supply 11. For example, the temperature sensor may be attached to one surface of the power supply 11 (e.g., a battery) and/or mounted on one surface of a printed circuit board. For example, the aerosol generating device 1 may include a power protection circuit module (PCM), and the temperature sensor may be disposed adjacent to the power supply 11 together with the power PCM.

According to an embodiment, the temperature sensor may be disposed inside a housing (not shown) of the aerosol generating device 1 to detect an internal temperature of the housing.

According to an embodiment, the puff sensor may detect a puff of a user.

For example, the puff sensor may include a pressure sensor. The pressure sensor may output a signal corresponding to an internal pressure of the aerosol generating device 1, and the controller 12 may detect the puff of the user, based on the signal corresponding to the internal pressure. The internal pressure of the aerosol generating device 1 may correspond to pressure of an airflow path along which gas flows. The puff sensor may be disposed to correspond to the airflow path along which gas flows, in the aerosol generating device 1.

As another example, the puff sensor may include a temperature sensor. When the user' puff occurs, a temporary temperature drop may occur in the airflow path, a space where an aerosol generating article is inserted (hereinafter, an insertion space), the heater 18, etc. The controller 12 may detect the user's puff, based on a signal corresponding to the temperature of the airflow path, etc. output from the temperature sensor.

As another example, the puff sensor may include both a pressure sensor and a temperature sensor. In this case, the temperature sensor may measure a temperature that is used to correct an internal pressure measured by the pressure sensor. For example, the puff sensor may correct the signal corresponding to the internal pressure, based on the temperature measured by the temperature sensor, and may output the corrected signal. As another example, the puff sensor may output the signal corresponding to the temperature measured by the temperature sensor, and the signal corresponding to the internal pressure measured by the puff sensor. In this case, the controller 12 may receive the signals, and may correct the signal corresponding to the internal pressure, based on the signal corresponding to the temperature.

As another example, the puff sensor may include a capacitance sensor. In the present disclosure, the capacitance sensor may also be referred to as a cap sensor or a capacitive sensor. When the user's puff occurs, a temperature change and/or aerosol flow may occur within the insertion space of the aerosol generating article, and accordingly, an internal permittivity of the insertion space may change. The controller 12 may detect the user's puff, based on a signal corresponding to the internal permittivity, etc. of the insertion space output by the temperature sensor.

The puff sensor is not limited to the aforementioned examples, and may be implemented using various sensors for detecting the user's puff.

According to an embodiment, the insertion detection sensor may detect insertion and/or removal of the aerosol generating article. The insertion detection sensor may be provided around the insertion space. The insertion detection sensor may also include any combination of the aforementioned examples.

For example, the insertion detection sensor may include a capacitance sensor. The capacitance sensor may include at least one conductor. The at least one conductor may be arranged adjacent to the insertion space. When the aerosol generating article is inserted into or removed from the insertion space, a permittivity around the conductor may change. The controller 12 may detect the insertion and/or removal of the aerosol generating article, based on a signal corresponding to the internal permittivity, etc. of the insertion space output by the capacitance sensor.

As another example, the insertion detection sensor may include an inductive sensor. The inductive sensor may include at least one coil. The at least one coil may be disposed adjacent to the insertion space. When the aerosol generating article (e.g., a wrapper of the aerosol-generating article) includes a conductor and is inserted into or removed from the insertion space, a change in a magnetic field may occur around a coil where a current flows. The controller 12 may detect insertion and/or removal of the aerosol generating article including the conductor, based on the characteristics (e.g., a frequency, a current value, a voltage value, an inductance value, and an impedance value of an alternating current) of a current output or detected by the inductive sensor. Alternatively, the aerosol generating article (e.g., a medium portion of the aerosol generating article) may include a susceptor (SUS), etc. Even in this case, a change in the magnetic field around the coil may occur based on the insertion or removal of the susceptor, etc. within the insertion space, and the controller 12 may also detect the insertion and/or removal of the aerosol generating article, based on the characteristics of the current of the inductive sensor.

The insertion detection sensor is not limited to the aforementioned examples, and may be implemented using any of various sensors (e.g., a proximity sensor) for detecting insertion and/or removal of the aerosol generating article. The insertion detection sensor may also include any combination of the aforementioned examples. According to an embodiment, the insertion detection sensor may include a switch, etc. for detecting compression performed by the aerosol generating article.

According to an embodiment, the reuse detection sensor may detect whether the aerosol generating article is reused For example, the reuse detection sensor may be a color sensor for detecting a color of the aerosol generating article. When the aerosol generating article is used by the user, a change in the color of a portion of the wrapper surrounding the outside of the aerosol generating article may occur due to generated aerosol or heating. The color sensor may output a signal corresponding to optical characteristics (e.g., a wavelength of light) corresponding to the color of the wrapper, based on light reflected by the wrapper. When a change in the color of the portion of the wrapper is detected, the controller 12 may determine that the aerosol generating article inserted into the insertion space has already been used.

According to an embodiment, the overwetting detection sensor may detect whether the aerosol generating article is in an overwetting state. For example, the overwetting detection sensor may include a capacitance sensor. The capacitance sensor may include at least one conductor disposed adjacent to the insertion space. The controller 12 may detect whether the aerosol generating article is in an overwetting state, based on the level of a signal corresponding to a permittivity, etc. output by the capacitance sensor. For example, the controller 12 may check a level range including the level of the signal, based on a look-up table, and may determine a moisture content for the aerosol generating article, based on the checked level range.

According to an embodiment, the cigarette identification sensor may detect whether the aerosol generating article is authentic, and/or detect the type of the aerosol generating article.

For example, the cigarette identification sensor may include an optical sensor for detecting an identification material (or an identification mark) located on an outer surface (e.g., a wrapper) of the aerosol generating article. The optical sensor may radiate light toward the identification material (or the identification mark) of the aerosol generating article, and may detect the authenticity and/or the type of the aerosol generating article, based on the reflected light. For example, the identification material may include a material that emits light of a wavelength in a specific band, based on the radiated light. The controller 12 may detect the authenticity and/or the type of the aerosol generating article, based on the range of the wavelength.

As another example, the cigarette identification sensor may include a capacitance sensor. According to the types of aerosol generating article inserted into the insertion space, the internal permittivity of the insertion space may vary. The controller 12 may detect he authenticity of and/or the type of the aerosol generating article, based on the signal corresponding to the internal permittivity, etc. of the insertion space output by the capacitance sensor.

As another example, the cigarette identification sensor may include an inductive sensor. When a conductor is included in the wrapper and/or interior (e.g., a medium portion) of the aerosol generating article inserted into the insertion space, the characteristics of a current detected by the inductive sensor (e.g., a frequency, a current value, a voltage value, an inductance value, and an impedance value of an AC current) may differ according to the types of aerosol generating article inserted into the insertion space. The controller 12 may detect he authenticity of and/or the type of the aerosol generating article, based on the characteristics of a current output by the capacitance sensor or detected by the inductive sensor.

The cigarette identification sensor is not limited to the aforementioned examples, and may be implemented using any of various sensors for detecting whether the aerosol generating article is authentic, and/or detecting the type of the aerosol generating article. The cigarette identification sensor may also include any combination of the aforementioned examples.

According to an embodiment, the cartridge detection sensor may detect insertion and/or removal of the cartridge. For example, the cartridge detection sensor may include an inductive sensor, a capacitance sensor, a resistance sensor, a hall sensor (a hall IC) using a hall effect, and/or an optical sensor.

According to an embodiment, the cap detection sensor may detect insertion and/or removal of the cap. For example, the cap detection sensor may include an inductive sensor, a capacitance sensor, a resistance sensor, a hall sensor (a hall IC), and/or an optical sensor. The cap may include a structure that covers at least a portion of the cartridge mounted on or inserted into the aerosol generating device 1 or covers at least a portion of the housing of the aerosol generating device 1. When the cap is mounted on or removed from the housing, the cap detection sensor may output a signal corresponding to the mounting or removal of the cap. The controller 12 may detect the mounting or removal of the cap, based on a signal corresponding to the mounting or removal.

According to an embodiment, the movement detection sensor may detect a motion of the aerosol generating device 1. The movement detection sensor may be implemented using at least one of an acceleration sensor and a gyro sensor.

According to an embodiment, the sensor unit 13 may further include at least one of a humidity sensor, a pressure sensor, a magnetic sensor, a global positioning sensor (GPS), or a proximity sensor, in addition to the above-described sensors. Functions of the sensors would be instinctively understood by one of ordinary skill in the art in view of their names and thus detailed descriptions thereof will be omitted herein.

According to an embodiment, the output unit 14 may output information about the state of the aerosol generating device 1. The output unit 14 may include a display, a haptic unit, and/or a sound output unit, but embodiments are not limited thereto. For example, information about the aerosol generating device 1 may include a charging/discharging state of the power supply 11 of the aerosol generating device 1, preheating states of the heater 18, an insertion/removal state of the aerosol generating article and/or the cartridge, a mounting and/or removal state of the cap, or a state in which use of the aerosol generating device 1 is limited (e.g., detection of an abnormal article). The display may visually provide the information about the state of the aerosol generating device 1 to the user. For example, the display may include a light-emitting diode (LED), a liquid crystal display (LCD), an organic light-emitting diode (OLED), etc. When the display includes a touch pad, the display may also be used as an input unit 15. A haptic unit may tactually provide the information about the state of the aerosol generating device 1 to the user. For example, the haptic unit may include a vibration motor, a piezoelectric element, an electrical stimulation device, etc. The sound output unit may acoustically provide the information about the aerosol generating device 1 to the user. For example, the sound output unit may convert an electrical signal into a sound signal and may output the sound signal to the outside.

According to an embodiment, the power supply 11 may output power for operating the aerosol generating device 1. The power supply 11 may include one or more batteries. The power supply 11 may supply power so that the heater 18 may be heated. In addition, the power supply 11 may supply power required for operations of the controller 12, the sensor unit 13, the output unit 14, the input unit 15, the communication unit 16, the memory 17, etc. which are other components included in the aerosol generating device 1. The power supply 11 may be a rechargeable battery or a disposable battery. For example, the power supply 11 may be a lithium polymer (LiPoly) battery, but embodiments are not limited thereto. The power supply 11 may be a rechargeable (separate-type) battery (hereinafter, a detachable battery. The detachable battery may be mounted on a battery accommodation part provided within the aerosol generating device 1, or may be removed from the battery accommodation part. The detachable battery may be charged either via wire or wirelessly.

According to an embodiment, the heater 18 may heat a medium and/or an aerosol generating material within the aerosol generating article and/or the cartridge by receiving power from the power supply 11. The aerosol generating device 1 may include a heater 18 for heating the aerosol generating article and/or a cartridge heater for heating the cartridge (i.e., a solid and/or liquid medium).

According to an embodiment, the heater 18 may be electro-resistive heaters. For example, the electro-resistive heaters may include an electro-resistive material, such as a metal including titanium, zirconium, tantalum, platinum, nickel, cobalt, chromium, hafnium, niobium, molybdenum, tungsten, tin, gallium, manganese, iron, copper, stainless steel, nichrome, or the like, or a metal alloy. The electro-resistive heaters may be implemented using a metal heating wire, a metal heating plate on which an electric conductive track is disposed, a ceramic heating body, or the like.

According to an embodiment, the heater 18 may be induction heating heaters. For example, the induction heating heaters may include a susceptor that generates heat through a magnetic field. The magnetic field may be generated from an induction coil by an AC current flowing through the induction coil. The generated magnetic field may penetrates a heater and an eddy current may be generated by the susceptor. The susceptor may be heated based on the generation of the eddy current. According to an embodiment, the susceptor may be included within the aerosol generating article (e.g., the medium portion). Even in this case, the susceptor included within the aerosol generating article may be heated by the induction coil.

The heater 18 are not limited to the aforementioned examples, and may include or be replaced with various heating methods, structures, components, etc. for heating the aerosol generating article and/or the cartridge.

According to an embodiment, the input unit 15 may receive information input by the user. For example, the input unit 15 may include a touch panel, a button, a keypad, a dome switch, a jog wheel, a jog switch, etc.

According to an embodiment, the memory 17 is hardware for storing various kinds of data processed in the aerosol generating device 1, and may store pieces of data that have been processed and are to be processed by the controller 12. For example, the memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. For example, the memory 17 may store data about an operating time of the aerosol generating device 1, a maximum number of puffs, a current number of puffs, at least one temperature profile, and the user's smoking pattern.

According to an embodiment, the communication unit 16 may include at least one component for communication with another electronic device (e.g., a portable electronic apparatus). For example, the communication unit 16 may include a Bluetooth communication unit, a Bluetooth Low Energy (BLE) communication unit, an Near Field Communication (NFC) communication unit, a wireless local area network (WLAN) communication unit, a ZigBee communication unit, an infrared Data Association (IrDA) communication unit, a Wireless Fidelity Direct (WFD) communication unit, an ultra wideband (UWB) communication unit, an Adaptive Network Topology (Ant)+communication unit, a cellular network communication unit, an Internet communication unit, a computer network (e.g., a LAN or WAN) communication unit, etc.

According to an embodiment, the controller 12 may control overall operations of the aerosol generating device 1. For example, the controller 12 may include at least one processor. The controller 12 may be implemented as an array of a plurality of logic gates, or as a combination of a general-use micro controller unit (MCU) (or a microprocessor) and a memory in which a program executable by the general-use MCU is stored. It will also be understood by one of ordinary skill in the art to which the present embodiment pertains that the controller 12 may be implemented as other types of hardware.

According to an embodiment, the controller 12 may control supplying of the power of the power supply 11 to the heater 18, thereby controlling the temperatures of the heater 18. The controller 12 may control the temperatures of the heater 18 and/or power supplied to the heater 18, based on the temperatures of the heater 18 detected using the temperature sensor (e.g., the sensor unit 13). The controller 12 may control the temperatures of the heater 18 and/or the power supplied to the heater 18, based on a temperature profile and/or a power profile stored in the memory 17.

According to an embodiment, the controller 12 may control power (e.g., a voltage and/or a current) supplied to the heater 18 by controlling a power conversion circuit (not shown) electrically connected to the heater 18 and the power supply 11. For example, the power conversion circuit may include a DC/DC converter (e.g., a buck converter, a buck-boost converter, a boost converter, or a Zener diode) that converts power that is to be supplied to the heater 18, and a DC/AC converter (e.g., an inverter) that converts power that is to be supplied to an induction coil (not shown). The DC/AC inverter may be implemented as a full-bridge circuit or half-bridge circuit including a plurality of switching elements. For example, the power conversion circuit may include at least one switching element, such as a bipolar junction transistor (BJT) and a field effect transistor (FET).

According to an embodiment, the controller 12 may control the current and/or voltage supplied to the heater 18 by controlling the frequency and/or duty ratio of a current pulse input to the at least one switching element of the power conversion circuit. A duty ratio with respect to an on/off operation of the switching element may correspond to a ratio of an output voltage of the power conversion circuit to an output voltage of the power supply 11.

According to an embodiment, the controller 12 may control power that is supplied to the heater 18, by using at least one method among a pulse width modulation (PWM) method and a proportional-integral-differential (PID) method. For example, the controller 12 may control a current pulse having a certain frequency and a duty ratio to be supplied to the heater 18, by using the PWM method. The controller 12 may control the power supplied to the heater 18, by adjusting the frequency and duty ratio of the current pulse. For example, the controller 12 may determine a target temperature that is a target of control, based on the temperature profile. The controller 12 may control the power supplied to the heater 18, by using a PID method, which is a feedback control method using a difference value between the temperatures of the heater 18 and the target temperature thereof, a value obtained by integrating the difference value according to the flow of time, and a value obtained by differentiating the difference value according to the flow of time.

According to an embodiment, the controller 12 may determine target power that is a target of control, based on the power profile. The controller 12 may control the power supplied to the heater 18 to correspond to preset target power, according to the flow of time.

According to an embodiment, the controller 12 may detect the user's puff by detecting the power supplied to the heater 18. In more detail, the controller 12 may control the power supplied to the heater 18, by using the PID method. When the user' puff occurs, a temporary temperature drop may occur in a space where the aerosol generating article is inserted (hereinafter, the insertion space), the heater 18, etc. Accordingly, a change may occur in the power (or current) supplied to the heater 18 during power control using the PID method. The controller 12 may detect the user's puff, based on a change in the power that is controlled.

According to an embodiment, the controller 12 may prevent the heater 18 from being heated. For example, the controller 12 may control an operation of the power conversion circuit so that the amount of the power supplied to the heater 18 is reduced or the power supply to the heater 18 is stopped, based on the temperatures of the heater 18 exceeding a preset limit temperature.

According to an embodiment, the controller 12 may control charging/discharging of the power supply 11. For example, the controller 12 may check the temperature of the power supply 11 by using the temperature sensor (e.g., the sensor unit 13). When the temperature of the power supply 11 is equal to or greater than a first limit temperature, the controller 12 may block charging of the power supply 11. When the temperature of the power supply 11 is greater than or equal to a second limit temperature, the controller 12 may stop using (e.g., discharging) the power stored in the power supply 11. The controller 12 may calculate the remaining capacity of the power stored in the power supply 11. For example, the controller 12 may calculate the remaining capacity of the power supply 11, based on a voltage and/or current sensing value of the power supply 11.

According to an embodiment, the controller 12 may control supply of power to the heater 18, based on a result of the sensing performed by the sensor 13.

According to an embodiment, the controller 12 may control supply of power to the heater 18, based on insertion and/or removal of the aerosol generating article into and/or the insertion space. For example, when it is determined using the insertion detection sensor (e.g., the sensor unit 13) that the aerosol generating article has been inserted into the insertion space, the controller 12 may control power to be supplied to the heater 18. When it is determined using the insertion detection sensor (e.g., the sensor unit 13) that the aerosol generating article has been removed from the insertion space, the controller 12 may block the supply of power to the heater 18. When the temperatures of the heater 18 are equal to or greater than a limit temperature or temperature change slopes of the heater 18 are equal to or greater than a set slope, the controller 12 may determine that the aerosol generating article has been removed from the insertion space.

According to an embodiment, the controller 12 may control power supply time periods and/or power supply amounts for the heater 18, based on the state of the aerosol generating article. For example, when it is determined using the overwetting detection sensor (e.g., the sensor unit 13) that the aerosol generating article is in an overwetting state, the controller 12 may increase the power supply time periods (e.g., preheating time periods) for the heater 18.

According to an embodiment, the controller 12 may control supply of power to the heater 18, based on reuse or non-reuse of the aerosol generating article. For example, when it is determined that the aerosol generating article has been used, the controller 12 may block supply of power to the heater 18.

According to an embodiment, the controller 12 may control supply of power to the heater 18, based on attachment and/or removal of the cartridge. For example, when it is determined using the cartridge detection sensor (e.g., the sensor unit 13) that the cartridge is in a separated state, the controller 12 may block supply of power to the heater 18 or may control power to be not supplied to the heater 18.

According to an embodiment, the controller 12 may control supply of power to the heater 18, based on whether the aerosol generating material of the cartridge has been exhausted. For example, when it is determined that the temperatures of the heater 18 exceed the limit temperature while the heater 18 are being preheated (i.e., in a preheating section), the controller 12 may determine that the aerosol generating material in the cartridge has been exhausted. When it is determined that the aerosol generating material of the cartridge has been exhausted, the controller 12 may cut off the supply of power to the heater 18.

According to an embodiment, the controller 12 may control the supply of power to the heater 18, based on whether use of the cartridge is possible. For example, when it is determined based on data stored in the memory 17 that a current number of puffs is equal to or greater than a maximum number of puffs set in the cartridge, the controller 12 may determine that the use of the cartridge is not possible. For example, when a total time period during which the heater 18 are heated is greater than or equal to a preset maximum time period or a total amount of power supplied to the heater 18 is greater than or equal to a preset maximum power amount, the controller 12 may determine that the use of the cartridge is not possible. In this case, the controller 12 may block supply of power to the heater 18 or may control power to be not supplied to the heater 18.

According to an embodiment, the controller 12 may control the supply of power to the heater 18, based on the user's puff. For example, the controller 12 may determine occurrence or non-occurrence of a puff and/or the intensity of the puff, by using the puff sensor (e.g., the sensor unit 13). When the number of puffs reaches the preset maximum of puffs or puffs are not sensed for a preset time period or more, the controller 12 may cut off the supply of power to the heater 18. When a puff is sensed, the controller 12 may control the supply of power to the heater 18.

According to an embodiment, the controller 12 may control supply of power to the heater 18, based on authenticity of the aerosol generating article (or the cartridge) and/or the type of the aerosol generating article. For example, the controller 12 may detect authenticity or of the aerosol generating article and/or the type of the aerosol generating article, by using the cigarette identification sensor (e.g., the sensor unit 13). For example, when the aerosol generating article (or the cartridge) is detected as counterfeit, the controller 12 may block supply of power to the heater 18. When the aerosol generating article (or the cartridge) is detected as authentic, the controller 12 may control (e.g., start) supply of power to the heater 18. As another example, the controller 12 may differently control power supply to the heater 18 according to the types of aerosol generating article (or cartridge). In more detail, when the aerosol generating article (or the cartridge) is detected as a first aerosol generating article (or a first cartridge), the controller 12 may control the temperatures and/or power of the heater 18, based on a first temperature profile (or a first power profile), and, when the aerosol generating article (or cartridge) is detected as a second aerosol generating article (or a second cartridge), may control the temperatures and/or power of the heater 18, based on a second temperature profile (or a second power profile).

According to an embodiment, the controller 12 may control the output unit 14, based on a result of the sensing performed by the sensor unit 13. For example, when the number of puffs counted using the puff sensor (e.g., the sensor unit 13) reaches a preset number, the controller 12 may control the output unit 14 to visually, tactually, and/or acoustically provide information indicating that the aerosol generating device 1 is about to be terminated. For example, the controller 12 may control the output unit 14 to visually, tactually, and/or acoustically provide information about the temperatures of the heater 18.

According to an embodiment, the controller 12 may store and update a history of an event occurred in the memory 17, based on certain event occurrence. For example, the event may include insertion detection of the aerosol generating article, heating start of the aerosol generating article, puff detection, puff end, overheat detection of the heater 18, detection of overvoltage application to the heater 18, heating end of the aerosol generating article, an operation such as power on/off of the aerosol generation device 1, charging start of the power supply 11, detection of overcharging of the power supply 11, and charging end of the power supply 11, which are performed by the aerosol generating device 1. For example, the history of the event may include, for example, a date and time of the event, and log data corresponding to the event. For example, when a predetermined event is insertion detection of the aerosol generating article, log data corresponding to the event may include data for a sensing value, etc. of the insertion detection sensor (e.g., the sensor unit 13). For example, when the predetermined event is overheating detection of the heater 18, the log data corresponding to the event may include data about, for example, the temperature of the heater 18, the voltage applied to the heater 18, and the current flowing through the heater 18.

According to an embodiment, the controller 12 may control the communication unit 16 to form a communication link with an external device, such as the user's mobile terminal.

According to an embodiment, when receiving data on authentication from the external device through the communication link, the controller 12 may dismiss limitation of the use of at least one function (e.g., a heating function) of the aerosol generating device 1. For example, the data on authentication may include the user's birthday, a unique number representing the user, and completion or non-completion of authentication of the user.

According to an embodiment, the controller 12 may transmit data on the state of the aerosol generating device 1 (e.g., a remaining capacity of the power supply 11, and an operating mode) to the external device via the communication link. The transmitted data may be output through, for example, a display of the external device.

According to an embodiment, when a request for a location search of the aerosol generating device 1 is received from the external device via the communication link, the controller 12 may control the output unit 14 to perform an operation corresponding to the location search. For example, the controller 12 may control the haptic unit to generate vibration, or may control the display to output an object corresponding to the location search and a search end.

According to an embodiment, when receiving firmware data from the external device via the communication link, the controller 12 may perform firmware update.

According to an embodiment, the controller 12 may transmit data on a sensing value of at least one sensor unit 13 to an external server (not shown) through the communication link, and may receive and store a learning model generated by learning sensing values from a server through machine learning, such as deep learning. The controller 12 may perform, for example, an operation of determining the user's inhaling pattern and an operation of generating a temperature profile, by using the learning model received from the server.

Although not shown in FIG. 1, the aerosol generating device 1 may further include a power supply protection circuit. The power protection circuit may include at least one switching element, and may cut off transmission path to the power supply 11 in response to overcharging and/or overdischarging of the power supply 11. The aerosol generating device 1 may further include a connection interface, such as a universal serial bus (USB) interface, and may transmit/receive information by being connected to another external device through the connection interface, or may charge the power supply 11.

The aerosol generating article as described herein may include at least one aerosol generating rod (e.g., a medium portion) and at least one filter rod. The heater 18 may be arranged to correspond to the at least one aerosol generating rod, and may be designed differently according to arrangement orders and/or locations of the aerosol generating rod and the filter rod. The aerosol generating rod may include at least one of nicotine, an aerosol generating material, and additives. For example, the aerosol generating material may include glycerin (e.g., vegetable glycerin (VG)) and/or propylene glycol (PG), but may also include various other materials. For example, the additives may include flavors and/or organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco and reconstituted tobacco). The tobacco material may be included in the aerosol generating rod in various forms, such as Cut Tobacco, granules, or powder. According to an embodiment, the additives of the aerosol generating rod may include an alkaline substance. Based on the basic material, the nicotine of the tobacco material included in the aerosol generating rod may have an alkaline pH (e.g., pH 7.0 or higher). In this case, freebase nicotine may be released from the aerosol generating rod even at low temperature. According to an embodiment, the aerosol generating rod may include two or more aerosol generating rods, wherein the two or more aerosol generating rods may include a tobacco material and/or a non-tobacco material, respectively. Although not shown, at least one aerosol generating rod and at least one filter rod may be individually and/or integrally wrapped by at least one wrapper. In the disclosure, the aerosol generating article may be referred to as a stick.

The cartridge mentioned in the disclosure may contain an aerosol generating material in any one state among a liquid state, a solid state, a gaseous state, a gel state, and the like. The aerosol generating material may include a liquid composition. For example, the liquid composition may be a liquid including a tobacco-containing material having a volatile tobacco flavor component, or may be a liquid including a non-tobacco material. The cartridge may include a storage containing an aerosol generating material and/or a liquid delivery unit impregnated with (containing) the aerosol-generating material. For example, the liquid delivery unit may include a wick or the like, such as a cotton fiber, a ceramic fiber, a glass fiber, or porous ceramic. The cartridge heater may be included in the cartridge, as a coil-shaped structure that is wound around the liquid delivery unit or in a structure in contact with one side of the liquid delivery unit. Alternatively, the cartridge heater may be included in an aerosol generating device 1 that is separable from the cartridge.

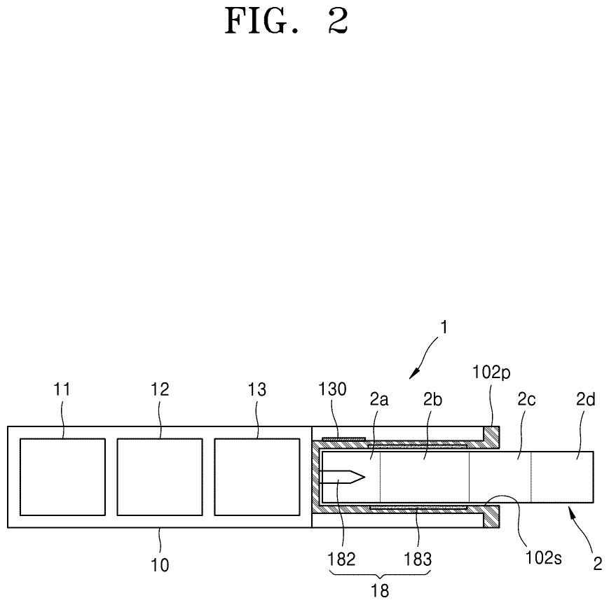

FIG. 2 illustrates an aerosol generating device according to an embodiment.

According to an embodiment, the aerosol generating device 1 may include a housing 10, the power supply 11, the controller 12, the sensor unit 13, and/or a heater 18 (e.g., the heater 18 of FIG. 1). However, the components included in the aerosol generating device 1 are not limited to those shown in FIG. 2. It may be understood by those skilled in the art that some of the components shown in FIG. 2 may be omitted or new components may be added. The aerosol generating device 1 illustrated in FIG. 2 may be referred to as an ‘internal and external heating type’ aerosol generating device that heats the inside and the outside of an aerosol generating article 2. In the drawings below, any description that overlaps with FIG. 1 will be omitted.

According to an embodiment, the housing 10 may provide a space opened upward so that the aerosol generating article 2 may be inserted. In the disclosure, the upwardly-opened space may be referred to as an insertion space. The insertion space may be recessed toward the inside of the body 10 by a certain depth so that at least a portion of the aerosol generating article 2 may be inserted thereinto. The depth of the insertion space may be equal to or greater than a length of a region in the aerosol generating article 2, in which an aerosol generating material and/or a medium is included. A lower end of the aerosol generating article 2 may be inserted into the housing 10, and an upper end of the aerosol generating article 2 may protrude to the outside of the housing 10. A user may inhale aerosol by holding, in his or her mouth, the upper end of the aerosol generating article 2 exposed to the outside.

According to an embodiment, the heater 18 may heat the aerosol-generating article 2.

Referring to FIG. 2, the aerosol-generating device 1 may include an accommodation portion 102p including an insertion space 102s for accommodating the aerosol-generating article 2. The heater 18 may include a first heater 182, which is an internal heating type heater, and a second heater 183, which is an external heating type heater. The first heater 182 may heat the interior of the aerosol-generating article 2, and the second heater 183 may heat the exterior of the aerosol-generating article 2.

The aerosol-generating device 1 includes a sensor 130 positioned on the exterior of the aerosol-generating article 2. The sensor 130 may detect the aerosol-generating article 2 inserted into the insertion space 102s of the aerosol-generating device 1. The sensor 130 may be placed outside the aerosol-generating article 2. The sensor 130 may be placed to correspond to the first heater 182 and may be placed in a different area from the area where the second heater 183 is placed.

The aerosol-generating article 2 may extend in a longitudinal direction of the aerosol-generating device 1. The aerosol-generating article 2 may include a first segment 2a, a second segment 2b, a third segment 2c, and a fourth segment 2d sequentially positioned in the extension direction of the aerosol-generating article 2.

When the aerosol-generating article 2 is inserted into the aerosol-generating device 1, the first heater 182 may be inserted into a portion of the first segment 2a. The sensor 130 may be placed outside the first segment 2a to correspond to the position of the first heater 182. The sensor 130 may be positioned outside a portion of the first segment 2a.

The second heater 183 may be placed outside the aerosol-generating article 2 and may extend from another portion of the first segment 2a toward the second segment 2b. The other portion of the first segment 2a where the second heater 183 is positioned may correspond to the remaining portion of the first segment 2a excluding the portion of the first segment 2a where the first heater 182 is positioned.

According to the aerosol-generating device 1 according to the above-described embodiment, the sensor 130 may be placed in a different area from the area where the second heater 183 is positioned. Because the heat generated from the second heater 183 is not directly transferred to the sensor 130, the reliability and durability of the sensor 130 may be improved.

According to an embodiment, the internal heating heater may extend long upward in a space (i.e., the insertion space) into which the aerosol generating article 2 is inserted. For example, the internal heating heater may include a rod-shaped heating element or a needle-shaped heating element. However, the internal heating heater may include any of various heating elements, such as a tube-shaped heating element or a plate-shaped heating element. The internal heating heater may be inserted through a lower side of the aerosol generating article 2.

According to an embodiment, the internal heating heater may include an electrically resistive heater and/or an induction heating heater.

For example, the electrically resistive heater may include an electrically resistive material on the inside (e.g., an inner hollow or an inner surface) or the outside (e.g., an outer surface), and may be heated as a current flows through the electrically resistive material. In this case, the electrically resistive heater may be electrically connected to the power supply 11, and may directly generate heat by receiving a current from the power supply 11.

For example, in the case of induction heating heaters, the aerosol generating device 1 may include the induction coil 181 surrounding at least a portion of the internal heating heater (e.g., being positioned outside to correspond to a length of at least a portion of the heater). In this case, a magnetic flux concentrator, etc. may be further included on the outside of the induction coil in order to increase the efficiency of induction heating. An induction heating heater may include a susceptor, and may generate heat based on a magnetic field generated by the induction coil. According to an embodiment, the internal heating heater being an induction heater (e.g., a susceptor) (or a heater module including the induction heating heater) may be arranged to be detachable from the housing 10.

According to an embodiment, the heater 182 may be multiple heaters. The multiple heaters may include a plurality of a first lower heating portions, and may be inserted into the aerosol generating article 2. The plurality of the first lower heating portions may be may be arranged in parallel along a longitudinal direction. The plurality of the first lower heating portions may operate as electrically resistive heaters and/or induction heating heaters, and may be sequentially heated or may be simultaneously heated. In this case, the plurality of the first lower heating portions may be respectively arranged at locations corresponding to longitudinal locations of two or more aerosol generating rods. Alternatively, the plurality of the first lower heating portions may be respectively arranged at locations corresponding to longitudinal locations of a first portion and a second portion of one aerosol generating rod. When the first heater 182 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the plurality of the first lower heating portions may be respectively arranged at locations corresponding to longitudinal locations of a first portion and a second portion of the first heater 182. Three or more heaters and/or three or more induction coils may be included.

According to an embodiment, a susceptor may be disposed (or included) in the inside (e.g., the medium portion) of the aerosol generating article 2, and the susceptor included within the aerosol generating article 2 may be implemented to generate heat, based on the magnetic field generated by the induction coil 181.

The second heater 183 may be an external heating heater.

According to an embodiment, the external heating heater may extend long upward around a space (i.e., the insertion space) into which the aerosol generating article 2 is inserted. For example, the external heating heater may be disposed to surround at least a portion of the insertion space. For example, the external heating heater may include a tubular shape (e.g., a cylindrical shape) including a hollow therein. The external heating heater may have a shape including a hollow on the inside and surrounding the hollow. In this case, the external heating heater may be supported by a polyimide film. A heater supported by such a film may be referred to as a film heater. The external heating heater may be disposed to surround at least a portion of the insertion space. The external heating heater may heat the outside of the aerosol generating article 2 inserted into the hollow.

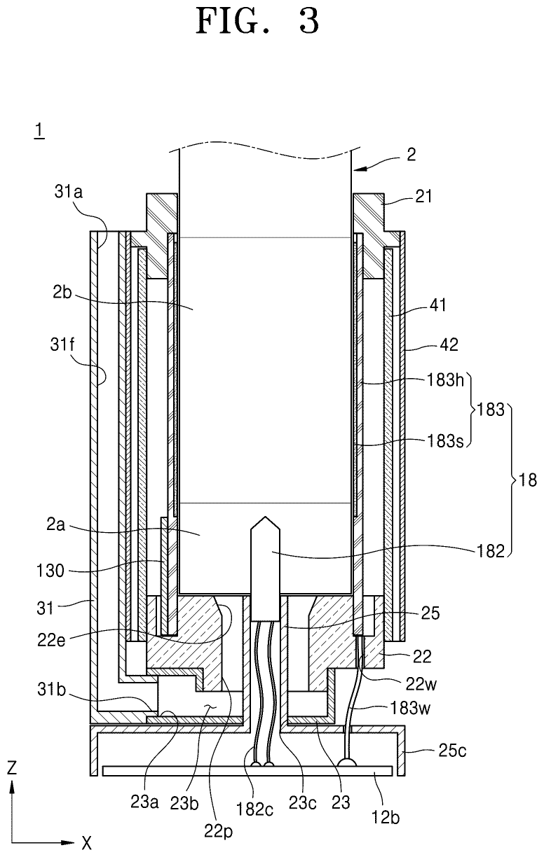

According to an embodiment, the external heating heater may include an electrically resistive heater and/or an induction heating heater. A description of FIG. 3 that overlaps with FIG. 2 will be omitted. In the case of induction heating heaters, the aerosol generating device 1 may include an external heating heater implemented as a tube-shaped susceptor, and may include the induction coil 181 surrounding at least a portion of the external heating heater (e.g., being positioned outside to correspond to a length of at least a portion of the heater). The induction coil 181 may include a fan coil. When the external heating heater is an electrically resistive heater, heat generation is possible through a current flow on a tube-shaped electrically resistive heater (e.g., a film heater), and thus the separate induction coil 181 may be omitted. Insulation may also be disposed on the outside of the external heating heater. Accordingly, the heat radiated outward by the second heater 183 and applied to the outside of the housing 10 may be reduced.

According to one embodiment, the second heater 183 may be multiple heaters, and may include a second lower heating portions. The second lower heating portions arranged side by side along the longitudinal direction so as to each surround at least a portion of the insertion space. The second lower heating portions may operate as electrically resistive heaters and/or induction heating heaters, and may be sequentially heated or may be simultaneously heated. When the second heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the second heater 183.

According to an embodiment, the aerosol generating device 1 may be provided with an airflow channel through which air flows. For example, the housing 10 may include a structure (e.g., a hole) in which air may be introduced from the outside into the housing 10. The air introduced into the housing 10 may be introduced into the aerosol generating article 2 through the lower end (i.e., an upstream side) of the aerosol generating article 2. Aerosol generated based on the heating of the aerosol generating article 2, together with the introduced air, may be inhaled into the user's mouth through the upper end (i.e., the downstream side) of the aerosol generating article 2.

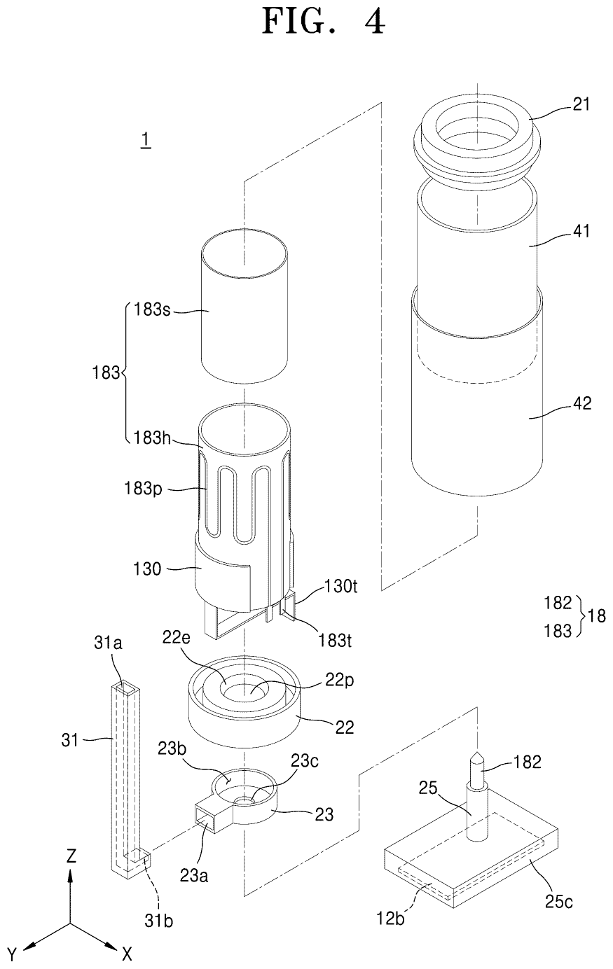

FIG. 3 is a cross-sectional view of an aerosol-generating device 1 according to another embodiment, and FIG. 4 is an exploded perspective view illustrating some elements of the aerosol-generating device 1 according to the embodiment illustrated in FIG. 3.

The aerosol-generating device 1 according to the embodiment illustrated in FIGS. 3 and 4 may generate an aerosol by heating an aerosol-generating article 2.

The aerosol-generating device 1 includes a heater 18 for heating the aerosol-generating article 2, and a sensor 130 for detecting the aerosol-generating article 2 inserted into the aerosol-generating device 1 and generating a signal.

The heater 18 includes a first heater 182 and a second heater 183. The first heater 182 may generate heat inside the aerosol-generating article 2 to heat the interior of the aerosol-generating article 2. The second heater 183 may generate heat outside the aerosol-generating article 2 to heat the outside of the aerosol-generating article 2.

The second heater 183 has a tubular shape for accommodating the aerosol-generating article 2. For example, the second heater 183 may have a hollow cylindrical shape.

The first heater 182 may be inserted into a portion of the aerosol-generating article 2 through one end of the aerosol-generating article 2 accommodated in the second heater 183. A lower portion of the first heater 182 may be supported by a first support 25.

The second heater 183 may include a heat transfer tube 183s and a film heater 183h surrounding the heat transfer tube 183s.

The heat transfer tube 183s may have a hollow cylindrical shape and accommodate the aerosol-generating article 2. The heat transfer tube 183s may include a thermally conductive material capable of transferring heat toward the aerosol-generating article 2. For example, the heat transfer tube 183s may include a thermally conductive metal material, such as aluminum or stainless steel.

The film heater 183h may be placed outside the heat transfer tube 183s. The film heater 183h may surround the heat transfer tube 183s and support the heat transfer tube 183s. The film heater 183h may include an insulating substrate and a heating pattern 183p positioned on the surface of the insulating substrate. When electricity is supplied to the heating pattern 183p, the heating pattern 183p may generate heat. The insulating substrate of the film heater 183h may include, for example, a flexible polyimide.

A second support 22 is coupled to one end of the second heater 183. The second support 22 may support the second heater 183. An inlet guide 21 is coupled to the other end of the second heater 183. The inlet guide 21, the second heater 183, and the second support 22 may form an accommodation space for accommodating an aerosol-generating article 2.

The upper end of the first heater 182 may protrude toward the accommodation space formed by the inlet guide 21, the second heater 183, and the second support 22.

The aerosol-generating article 2 may extend in a longitudinal direction (the Z-axis direction) of the aerosol-generating device 1. The aerosol-generating article 2 may include a first segment 2a and a second segment 2b which are sequentially positioned in an extension direction of the aerosol-generating article 2 from one end of the aerosol-generating article 2.

When the aerosol-generating article 2 is inserted into the aerosol-generating device 1, the first heater 182 may be inserted into a portion of the first segment 2a.

The second heater 183 may be placed outside the aerosol-generating article 2 and may extend from another portion of the first segment 2a to at least a portion of the second segment 2b. The other portion of the first segment 2a where the second heater 183 is positioned may correspond to the remaining portion of the first segment 2a excluding the portion of the first segment 2a where the first heater 182 is positioned.

According to a structure in which the first heater 182 is inserted into a portion of the aerosol-generating article 2 and the second heater 183 is positioned outside another portion of the aerosol-generating article 2, the entire area of the aerosol-generating article 2 may be effectively heated.

The first segment 2a and the second segment 2b of the aerosol-generating article 2 may include different materials. For example, the first segment 2a may include an aerosol-forming agent, such as glycerin, and thus, when the first segment 2a is heated, a large amount of aerosol may be generated. The second segment 2b may include a medium capable of imparting flavor and/or nicotine to the aerosol formed from the first segment 2a.

Because the first segment 2a and the second segment 2b perform different functions related to aerosol formation, the aerosol-generating device 1 may heat the first segment 2a and the second segment 2b to different temperature ranges. For example, the first segment 2 a may be heated to a temperature range of about 100 degrees Celsius to about 200 degrees Celsius by the first heater 182. In addition, the second segment 2 b may be heated by the second heater 183 at a temperature range of about 200 degrees Celsius to about 280 degrees Celsius.

The sensor 130 may detect that the aerosol-generating article 2 has been inserted into the aerosol-generating device 1 and/or that the aerosol-generating article 2 has been removed from the aerosol-generating device 1 and generate a signal. For example, the sensor 130 may detect a change in permittivity around the sensor 130 as the aerosol-generating article 2 is inserted into or removed from the aerosol-generating device 1 and generate a signal. As another example, the sensor 130 may detect a change in permittivity that varies depending on the type of aerosol-generating article 2 inserted into the aerosol-generating device 1 and generate a signal indicating the type of aerosol-generating article 2.

The sensor 130 may be placed outside the aerosol-generating article 2. The sensor 130 may be placed to correspond to the first heater 182 inserted into the interior of the aerosol-generating article 2. The phrase ‘the position of the sensor 130 corresponds to the first heater 182’ may mean that the positions of the sensor 130 and the first heater 182 correspond to each other based on the direction (the Z-axis direction) in which the aerosol-generating article 2 extends.

The sensor 130 may be positioned outside an area of the first segment 2a. The sensor 130 may be placed in an area different from the area where the second heater 183 is placed outside the aerosol-generating article 2. The sensor 130 and the second heater 183 may be sequentially placed in the direction in which the aerosol-generating article 2 extends. For example, the sensor 130 and the second heater 183 may be spaced apart from each other in the extension direction of the aerosol-generating article 2.

According to a structure in which the sensor 130 is placed in a different area from the area where the second heater 183 is placed, the influence of heat generated from the second heater 183 on the sensor 130 may be reduced. That is, because the sensor 130 is placed in a different area from the area where the second heater 183 is placed, the heat generated from the second heater 183 is not directly transferred to the sensor 130, thereby ensuring the operational reliability and durability of the sensor 130.

An air supply port 22p may be formed between the first support 25 and the second support 22. Air flowing from the outside of the aerosol-generating device 1 toward the inside of the aerosol-generating device 1 may be supplied toward one end of the aerosol-generating article 2 through the air supply port 22p.

The second support 22 may extend in a circumferential direction of one end of the second heater 183 to surround the first support 25. The second support 22 may have a plate shape or a ring shape having a through hole in the center thereof. The first support 25 supporting the first heater 182 is positioned to pass through the through hole in the center of the second support 22. The air supply port 22p may be formed by the inner wall of the second support 22 facing the first support 25 and the outer wall of the first support 25.

The aerosol-generating device 1 may include an introduction tube 31 that allows external air to be introduced into the interior of the aerosol-generating device 1. The introduction tube 31 may extend in an extension direction of the aerosol-generating device 1. The introduction tube 31 may extend from the outside of the second heater 183 in an extension direction of the second heater 183. The introduction tube 31 includes an inlet hole 31a that is open to the outside, an exhaust hole 31b that is open toward the air supply port 22p inside the aerosol-generating device 1, and an internal flow path 31f through which air may flow.

The external air introduced into the interior of the aerosol-generating device 1 via the introduction tube 31 may flow along the internal flow path 31f of the introduction tube 31 that is separated from the external surface of the second heater 183.

The air supply port 22p may include an expansion portion 22e that expands in size toward one end of the aerosol-generating article 2. The expansion portion 22e may be formed by increasing, toward the aerosol-generating article 2, the diameter of the end of the air supply port 22p that is open toward one end of the aerosol-generating article 2. The expansion portion 22e may be formed by a curved surface or a sloped surface that slopes toward the aerosol-generating article 2.

Air from the air supply port 22p may pass through the expansion portion 22e that expands in size at the end of the air supply port 22p and smoothly flow into the interior of the aerosol-generating article 2 through the surface of one end of the aerosol-generating article 2. A sufficient amount of air may be supplied at an appropriate pressure to one end of the aerosol-generating device 1 by the expansion portion 22e.

The aerosol-generating device 1 may include a sealing portion 23 placed between the introduction tube 31 and the air supply port 22p The sealing portion 23 may allow air in the introduction tube 31 to flow to the air supply port 22p. The sealing portion 23 may include a connection hole 23a communicating with the exhaust hole 31b of the introduction tube 31. The sealing portion 23 may include a chamber 23b having an empty interior. One side of the chamber 23b is connected to the connection hole 23a, and the other side of the chamber 23b is connected to the air supply port 22p. Air introduced into the chamber 23b through the connection hole 23a may be delivered to the air supply port 22p.

The sealing portion 23 may include a bottom hole 23c through which the first support 25 passes. The sealing portion 23 may include an elastic material, such as rubber or silicone. The bottom hole 23c of the sealing portion 23 and the outer surface of the first support 25 are in close contact with each other, and thus, the bottom hole 23c of the sealing portion 23 and the outer surface of the first support 25 may be sealed.

In addition, the upper surface of the sealing portion 23 may be coupled to the lower side of the second support 22, and thus, a joint portion between the upper surface of the sealing portion 23 and the lower side of the second support 22 may be sealed.

The first support 25 and/or the second support 22 are completely sealed by the sealing portion 23. Therefore, a phenomenon, in which droplets generated by condensation of a portion of the aerosol generated from the aerosol-generating article 2 leak into another space inside the aerosol-generating device 1 through the first support 25 and the second support 22, may be reduced.

A terminal 183t is placed at one end of the film heater 183h. The terminal 183t may be electrically connected to the heating pattern 183p and may protrude downward from one end of the film heater 183h. A connection wire 183w may be electrically connected to the terminal 183t of the film heater 183h. The connection wire 183w may extend to a lower portion of the second support 22 through a wire passage 22w of the second support 22.

The other end of the first support (25) may protrude downward through the bottom hole (23c) of the sealing portion (23). The other end of the first support 25 may be integrally connected to a component bracket 25c. For example, the first support 25 and the component bracket 25c may be integrally formed as a single body by a plastic injection molding process. The component bracket 25c may include a circuit board 12b therein.

The first heater 182 supported by the first support 25 may be electrically connected to the heater wire 182c. The heater wire 182c may extend downward along the inside of the first support 25 and be electrically connected to the circuit board 12b inside the component bracket 25c.

In addition, the connection wire 183w electrically connected to the terminal 183t of the second heater 183 may be electrically connected to the circuit board 12b through the component bracket 25c.

The aerosol-generating device 1 may further include an insulating tube 41 placed outside the second heater 183. One end of the insulating tube 41 is connected to the inlet guide 21, and the other end of the insulating tube 41 is connected to the second support 22. The insulating tube 41 may be spaced apart from the outer surface of the film heater 183h toward the outside. The insulating tube 41 may block heat emitted from the film heater 183h toward the outside. The insulating tube 41 may include, for example, a vacuum space or a heat-blocking material, such as a graphite sheet, therein.

By means of the insulating tube 41, heat generated from the first heater 182 and the second heater 183 may be reduced from being transferred to the outside of the aerosol generating device 1.

The aerosol generating device 1 may further include an electromagnetic shielding tube 42 placed outside the insulating tube 41. The electromagnetic shielding tube 42 may be, for example, a heat-blocking film including graphite.

According to the electromagnetic shielding tube 42, electromagnetic waves that may be generated during the operations of the first heater 182 and the second heater 183 may be prevented from leaking to the outside of the aerosol generating device 1.

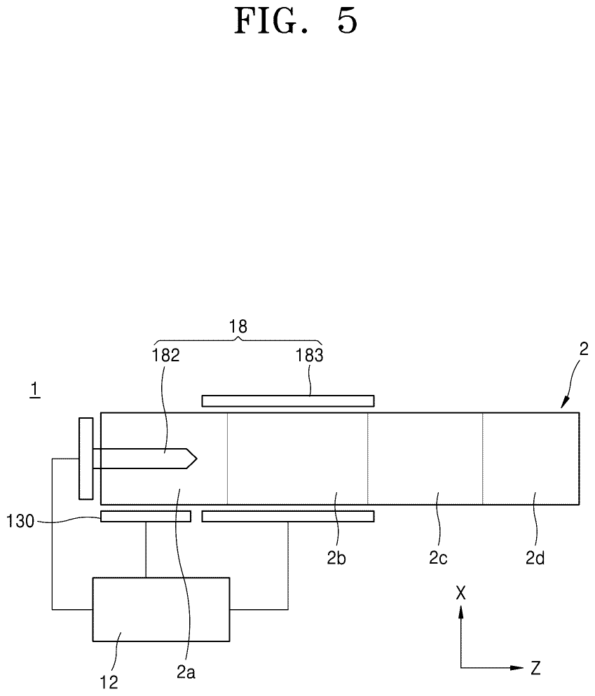

FIG. 5 is a view for explaining an aerosol-generating device 1 according to another embodiment.

The aerosol-generating device 1 according to the embodiment shown in FIG. 5 includes a heater 18 for heating a portion of an aerosol-generating article 2 extending in one direction (the Z-axis direction), a sensor 130 for detecting the aerosol-generating article 2, and a controller 12 for controlling the heater 18 based on a signal from the sensor 130.

The aerosol-generating article 2 may include a first segment 2a, a second segment 2b, a third segment 2c, and a fourth segment 2d sequentially positioned in an extension direction of the aerosol-generating article 2. The first segment 2a may include an aerosol forming agent, such as glycerin, for generating aerosol. The second segment 2b may impart flavor and/or nicotine to the aerosol. The third segment 2c may cool the aerosol. The fourth segment 2d may function as a filter to filter out some substances in the aerosol.

The heater 18 includes a first heater 182 and a second heater 183 that generate heat when electricity is applied. For example, the first heater 182 and the second heater 183 may have different resistance temperature coefficients. As another example, the first heater 182 and the second heater 183 may have the same resistance temperature coefficient.

The first heater 182 may be inserted into a portion of the first segment 2a of the aerosol-generating article 2. The second heater 183 may be placed outside the aerosol-generating article 2. The second heater 183 may be placed in a portion different from the portion of the first segment 2a into which the first heater 182 is inserted. The phrase ‘the second heater 183 is placed in a portion different from the portion of the first segment 2a into which the first heater 182 is inserted’ may mean that the positions of the geometric centers of the first heater 182 and the second heater 183 are different in the extension direction of the aerosol-generating article 2. Accordingly, a portion of the first heater 182 and a portion of the second heater 183 may be positioned to overlap each other in the extension direction of the aerosol-generating article 2.

The sensor 130 may be placed outside the aerosol-generating article 2 to correspond to the first heater 182. The sensor 130 may be placed in a different area from the area where the second heater 183 is placed outside the aerosol-generating article 2. The sensor 130 may detect a change in permittivity as the aerosol-generating article 2 is inserted into the aerosol-generating device 1 and/or a change in permittivity as the aerosol-generating article 2 is removed from the aerosol-generating device 1 and generate a signal.

The controller 12 may control the heating operations of the first heater 182 and the second heater 183 based on a signal of the sensor 130. For example, the controller 12 may control the amount of power supplied to each of the first heater 182 and the second heater 183 or the power supply time, and thus, the first heater 182 and the second heater 183 may generate heat in different temperature ranges. As another example, the controller 12 may independently control the heating start time, heating duration time, heating stop time, etc. of each of the first heater 182 and the second heater 183. As another example, the controller 12 may control the first heater 182 and the second heater 183 based on different temperature profiles.

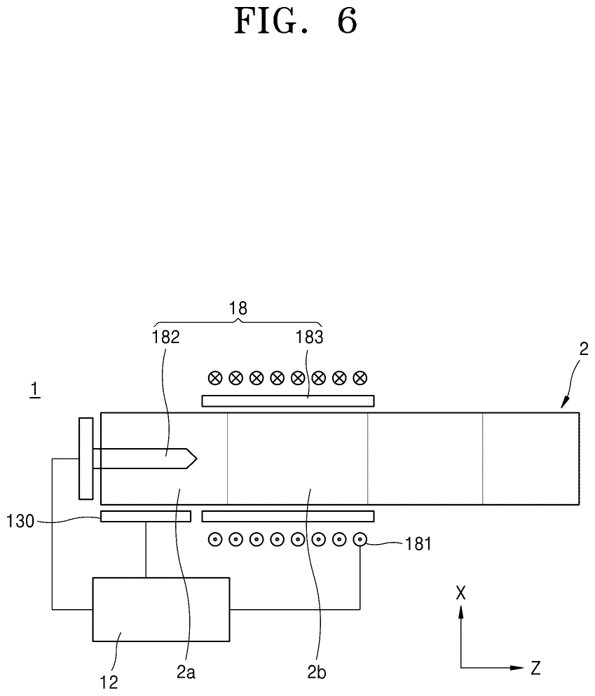

FIG. 6 is a view for explaining an aerosol-generating device 1 according to another embodiment.

A first heater 182 of the aerosol-generating device 1 according to the embodiment illustrated in FIG. 6 may be an electric resistance heater that generates heat when electricity is applied.

A second heater 183 may be an induction heating heater that generates heat by induction heating. The aerosol-generating device 1 may include an induction coil 181 that may generate an alternating magnetic field under control of a controller 12. The induction coil 181 may be placed outside the second heater 183 to surround the second heater 183. The second heater 183 may generate heat based on the alternating magnetic field generated from the induction coil 181.

A sensor 130 may be placed outside the aerosol-generating article 2 to correspond to the first heater 182. The sensor 130 may be placed in a different area from the area where the second heater 183 is placed outside the aerosol-generating article 2. In addition, the sensor 130 may be placed in a different area from the area where the induction coil 181 is placed outside the aerosol-generating article 2. In order to reduce the influence of the alternating magnetic field generated from the induction coil 181 on the sensor 130, the sensor 130 and the induction coil 181 may be spaced apart from each other in the extension direction (the Z-axis direction) of the aerosol-generating article 2.

The controller 12 may control the heating operations of the first heater 182 and the second heater 183 based on a signal of the sensor 130. The controller 12 may control the heating operation of the first heater 182 by controlling the power supplied to the first heater 182. In addition, the controller 12 may control the heating operation of the second heater 183 by controlling the electricity supplied to the induction coil 181.

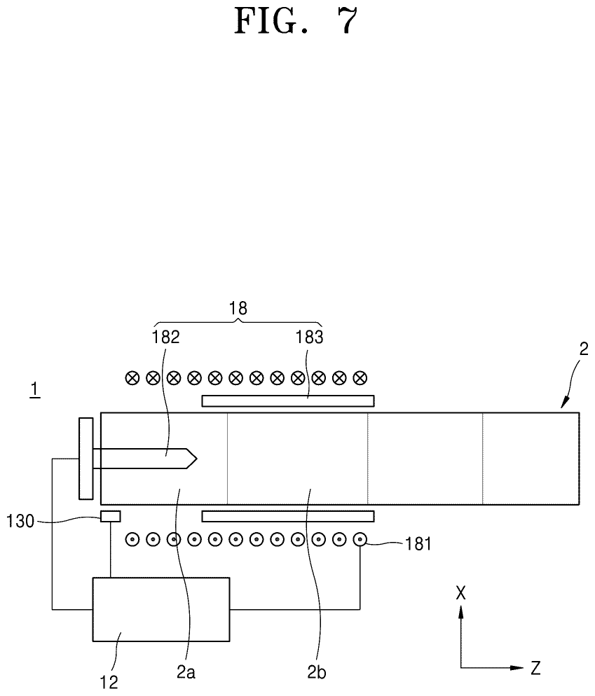

FIG. 7 is a view for explaining an aerosol-generating device 1 according to another embodiment.

Both a first heater 182 and a second heater 183 of the aerosol-generating device 1 according to the embodiment illustrated in FIG. 7 may be induction heating heaters that generate heat by induction heating.

The aerosol-generating device 1 may include an induction coil 181 that is controlled by a controller 12 and may generate an alternating magnetic field. The induction coil 181 may be placed outside the second heater 183 to surround at least a portion of the first heater 182 and at least a portion of the second heater 183.

The first heater 182 may heat the interior of the aerosol-generating article 2 by generating heat based on the alternating magnetic field generated from the induction coil 181. The second heater 183 can heat the outside of the aerosol-generating article 2 by generating heat based on the alternating magnetic field generated from the induction coil 181.

The sensor 130 may be placed outside the aerosol-generating article 2 to correspond to the first heater 182. The sensor 130 may be placed in a different area from the area where the second heater 183 is placed outside the aerosol-generating article 2. In addition, the sensor 130 may be placed in a different area from the area where the induction coil 181 is placed outside the aerosol-generating article 2. The phrase ‘the sensor 130 is placed in a different area from the area where the induction coil 181 is placed’ and the phrase ‘the sensor 130 is placed in a different area from the area where the second heater 183 is placed’ may mean that the sensor 130 is placed in a position different from the positions of the second heater 183 and the induction coil 181 based on the extension direction (the Z-axis direction) of the aerosol-generating article 2.

The sensor 130 and the induction coil 181 may be spaced apart from each other in the extension direction (the Z-axis direction) of the aerosol-generating article 2 so that the influence of the alternating magnetic field generated from the induction coil 181 on the sensor 130 is reduced.

The controller 12 may control the heating operations of the first heater 182 and the second heater 183 based on a signal of the sensor 130. The controller 12 may control the heating operations of the first heater 182 and the second heater 183 by controlling the electricity supplied to the induction coil 181.

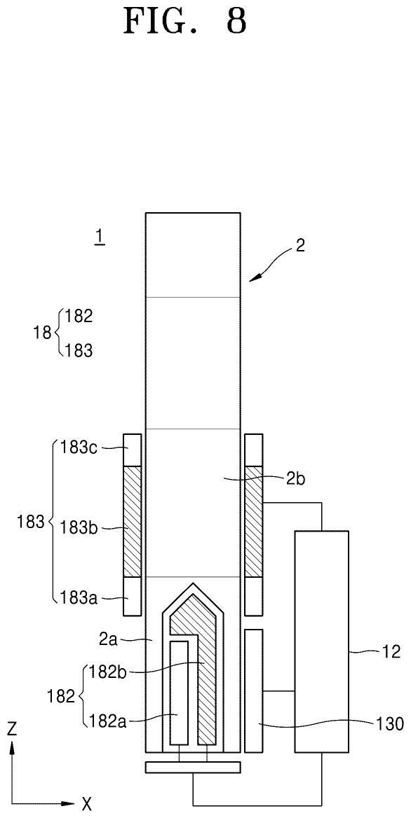

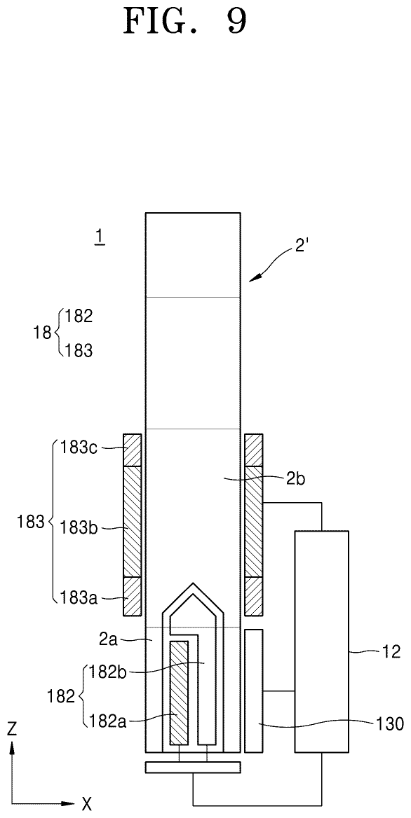

FIG. 8 is a view illustrating a state in which an aerosol-generating article 2 is inserted into an aerosol-generating device 1 according to another embodiment, and FIG. 9 is a view illustrating a state in which an aerosol-generating article 2′ of a different type from the aerosol-generating article 2 of FIG. 8 is inserted into an aerosol-generating device 1.

The types of the aerosol-generating article 2 inserted into the aerosol-generating device 1 of FIG. 8 and the aerosol-generating article 2 ′ inserted into the aerosol-generating device 1 of FIG. 9 are different from each other. The length of a first segment 2a of the aerosol-generating article 2 illustrated in FIG. 8 is greater than the length of a first segment 2a of the aerosol-generating article 2′ illustrated in FIG. 9. In addition, the length of a second segment 2b of the aerosol-generating article 2 illustrated in FIG. 8 is less than the length of a second segment 2b of the aerosol-generating article 2′ illustrated in FIG. 9.

The aerosol-generating device 1 according to the embodiments illustrated in FIGS. 8 and 9 may efficiently heat different types of aerosol-generating articles 2 and 2′.

The heater 18 of the aerosol-generating device 1 includes a first heater 182 that may be inserted into one end of the aerosol-generating article 2 or 2′ and a second heater 183 that may be positioned outside the aerosol-generating article 2 or 2′.

The first heater 182 may include first lower heating portions 182a and 182b that are partitioned to correspond to a portion of the aerosol-generating article 2 or 2′. For example, the first lower heating portions 182a and 182b may be partitioned in an extension direction (the Z-axis direction) in which the aerosol-generating article 2 or 2′ extends. The first lower heating portions 182a and 182b may include a short heater 182a that is formed to have a short length in the extension direction of the aerosol-generating article 2 or 2′ and a long heater 182b that is formed to have a long length in the extension direction.

A controller 12 may independently control each of the first lower heating portions 182a and 182b. For example, when only the short heater 182a generates heat, a short first segment 2a of the aerosol-generating article 2′ illustrated in FIG. 9 may be heated by the short heater 182a. Also, when only the long heater 182b generates heat or both the long heater 182b and the short heater 182a generate heat, a long first segment 2a illustrated in FIG. 8 may be heated. In FIGS. 8 and 9, the parts that perform the heating operations of the first lower heating portions 182a and 182b are indicated by hatching.

The phrase ‘the first lower heating portions 182a and 182b are partitioned to correspond to a portion of the aerosol-generating article 2 or 2′ may mean that the lengths of the first lower heating portions 182a and 182b in the extension direction of the aerosol-generating article 2 or 2′ are set to be different, as shown in FIGS. 8 and 9, and/or that the first lower heating portions 182a and 182b are arranged at different positions in the extension direction of the aerosol-generating article 2 or 2′.

The embodiments are not limited by the configurations of the first lower heating portions 182a and 182b shown in FIGS. 8 and 9. For example, the first lower heating portions 182a and 182b may have the same length or different lengths and may be placed at different positions in the extension direction of the aerosol-generating article 2 or 2′.

The second heater 183 may include second lower heating portions 183a, 183b, and 183c that are partitioned to correspond to another portion of the aerosol-generating article 2 or 2′. The phrase ‘the second lower heating portions 183a, 183b, and 183c are partitioned to correspond to another portion of the aerosol-generating article 2 or 2′ may mean that the positions of the second lower heating portions 183a, 183b, and 183c are determined to be different in a portion that is different from one portion of the aerosol-generating article 2 or 2′ in which the first heater 182 is placed in the extension direction of the aerosol-generating article 2 or 2′. However, as illustrated in FIGS. 8 and 9, some of the second lower heating portions 183a, 183b, and 183c may be positioned to overlap a portion of the first heater 182 in the extension direction of the aerosol-generating article 2 or 2′.

For example, the second heater 183 may be partitioned in the extension direction (the Z-axis direction) in which the aerosol-generating article 2 or 2′ extends. The second lower heating portions 183a, 183b, and 183c may be sequentially arranged in the extension direction of the aerosol-generating article 2 or 2′. The second lower heating portions 183a, 183b, and 183c may include an upstream heater 183a, an intermediate heater 183b, and a downstream heater 183c that are sequentially arranged in the extension direction of the aerosol-generating article 2 or 2′.

The embodiments are not limited by the number of second lower heating portions 183a, 183b, and 183c and the configurations thereof. For example, the number of second lower heating portions 183a, 183b, and 183c may be two, or four or more.

The lengths of the second lower heating portions 183a, 183b, and 183c in a direction along the aerosol-generating article 2 or 2′ may be different from each other. As another example, at least some of the second lower heating portions 183a, 183b, and 183c may have the same length.

The controller 12 may independently control the second lower heating portions 183a, 183b, and 183c. The intermediate heater 183b may be controlled by the controller 12 to generate heat to heat the second segment 2b having a short length in the aerosol-generating article 2 illustrated in FIG. 8. In addition, all of the upstream heater 183a, the intermediate heater 183b, and the downstream heater 183c may be controlled by the controller 12 to generate heat in order to heat the second segment 2b having a long length in the aerosol-generating article 2′ illustrated in FIG. 9. In FIGS. 8 and 9, the parts that perform the heating operations of the second lower heating portions 183a, 183b, and 183c are indicated by hatching.

The sensor 130 may detect that the aerosol-generating article 2 or 2′ has been inserted into the aerosol-generating device 1 and/or that the aerosol-generating article 2 or 2′ has been removed from the aerosol-generating device 1 and generate a signal. For example, the sensor 130 may detect a change in permittivity around the sensor 130 as the aerosol-generating article 2 or 2′ is inserted into or removed from the aerosol-generating device 1 and generate a signal. As another example, the sensor 130 may detect a change in permittivity that varies depending on the type of aerosol-generating article 2 or 2′ inserted into the aerosol-generating device 1 and generate a signal indicating the type of aerosol-generating article 2 or 2′.

The length of the first segment 2a of the aerosol-generating article 2 inserted into the aerosol-generating device 1 according to the embodiment illustrated in FIG. 8 is different from the length of the first segment 2a of the aerosol-generating article 2′ inserted into the aerosol-generating device 1 illustrated in FIG. 9. Accordingly, the sensor 130 may generate a signal, which indicates the type of aerosol-generating article 2 or 2′ inserted into the aerosol-generating device 1, by detecting a difference in permittivity resulting from different lengths of the first segment 2a.

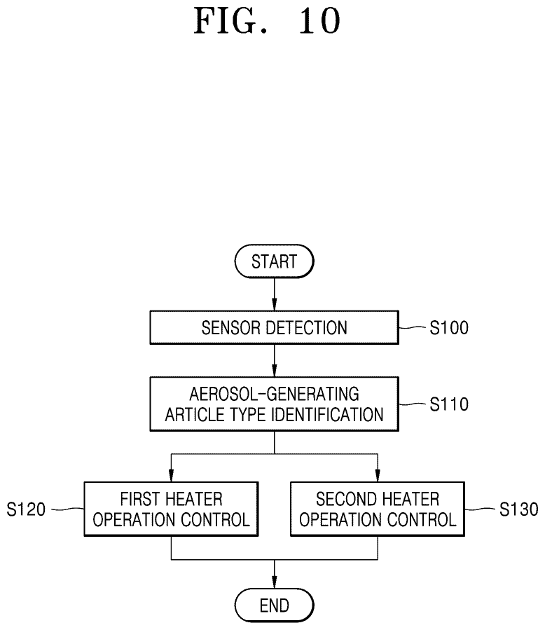

FIG. 10 is a flowchart illustrating an operation of the aerosol-generating device 1 according to the embodiments illustrated in FIGS. 1 to 9.

The flowchart illustrated in FIG. 10 may illustrate an example of the operation of the aerosol-generating device 1 in response to situations in which different types of aerosol-generating articles 2 and 2′ are inserted into the aerosol-generating device 1, as illustrated in FIGS. 8 and 9.

Operations illustrated in the flowchart of FIG. 10 may be executed by the controller 12, the sensor 130, the first heater 182, and the second heater 183.

In a sensor detection operation S100, the sensor 130 may detect the insertion of the aerosol-generating article 2 or 2′ into the aerosol-generating device 1 and the removal of the aerosol-generating article 2 or 2′ from the aerosol-generating device 1 and generate a signal.

When the sensor 130 detects the insertion of the aerosol-generating article 2 or 2′ into the aerosol-generating device 1 and generates a signal, the sensor 130 may generate a signal based on the type of the aerosol-generating article 2 or 2′.

In an aerosol-generating article type identification operation S110, the controller 12 may identify the type of the aerosol-generating article 2 or 2′ based on the signal generated by the sensor 130.

The controller 12 may execute a first heater operation control operation S120 and a second heater operation control operation S130 based on the type of the identified aerosol-generating article 2 or 2′. The first heater operation control operation S120 and the second heater operation control operation S130 may be simultaneously executed or sequentially executed at different times. For example, the controller 12 may select a temperature profile corresponding to the type of the identified aerosol-generating article 2 or 2′ from among predetermined temperature profiles. The controller 12 may apply the selected temperature profile to each of the first heater operation control operation S120 and the second heater operation control operation S130. A temperature profile applied to the first heater 182 in the first heater operation control operation S120 and a temperature profile applied to the second heater 183 in the second heater operation control operation S130 may be different from each other.

The aerosol-generating device 1 according to the embodiments described above includes the first heater 182 inserted into a portion of the aerosol-generating article 2 to heat the interior of the aerosol-generating article 2 and the second heater 183 positioned outside another portion of the aerosol-generating article 2 to heat the exterior of the aerosol-generating article 2, and thus, various regions of the aerosol-generating article 2 may be effectively heated.

In addition, based on a signal from the sensor 130, the controller 12 may control the heating operations of the first heater 182 and the second heater 183 in response to the type of the aerosol-generating article 2, and thus, various types of aerosol-generating articles 2 may be effectively heated.

The aerosol-generating device 1 according to embodiments is an aerosol-generating device for generating an aerosol by heating an aerosol-generating article 2, and includes a first heater 182 for generating heat inside the aerosol-generating article 2, a second heater 183 for generating heat outside the aerosol-generating article 2, and a sensor 130 for detecting the aerosol-generating article 2 and generating a signal, the sensor 130 being placed to correspond to the first heater 182 in a different area from an area where the second heater 183 is placed outside the aerosol-generating article 2.

According to an embodiment, at least one of the first heater 182 and the second heater 183 may generate heat when electricity is applied.

According to another embodiment, the aerosol-generating device 1 may further include an induction coil 181 that generates an alternating magnetic field when electricity is applied. At least one of the first heater 182 and the second heater 183 may generate heat by the alternating magnetic field of the induction coil 181.

According to another embodiment, the second heater 183 may have a tubular shape for accommodating the aerosol-generating article 2. The first heater 182 may be inserted into one end of the aerosol-generating article 2 accommodated in the second heater 183.

According to another embodiment, the aerosol-generating device 1 may further include a first support 25 that supports the first heater 182. In addition, the aerosol-generating device 1 may further include a second support 22 that supports one end of the second heater 183. In addition, the aerosol-generating device 1 may further include an air supply port 22p formed between the first support 25 and the second support 22. Air introduced from the outside may be supplied to the one end of the aerosol-generating article 2 through the air supply port 22p.

According to another embodiment, the second support 22 may extend in a circumferential direction of the one end of the second heater 183 to surround the first support 25. The air supply port 22p may be formed by an inner wall of the second support 22 facing the first support 25 and an outer wall of the first support 25.

According to another embodiment, the aerosol-generating device 1 may further include an introduction tube 31 that allows external air to be introduced into the interior of the aerosol-generating device 1. In addition, the aerosol-generating device 1 may further include a sealing portion 23 that is placed between the introduction tube 31 and the air supply port 22p to allow air in the introduction tube 31 to flow into the air supply port 22p. At least one of the first support 25 and the second support 22 may be sealed by the sealing portion 23.

According to another embodiment, the second heater 183 may extend in one direction. In addition, the introduction tube 31 may extend in the one direction. External air introduced into the interior of the aerosol-generating device 1 by the introduction tube 31 may flow along a flow path 31f within the introduction tube 31 separated from the outer surface of the second heater 183.

According to another embodiment, the air supply port 22p may include an expansion portion 22e. The expansion portion 22e may be formed by expanding the size of at least a portion of the air supply port 22p toward the one end of the aerosol-generating article 2.

According to another embodiment, the second heater 183 may accommodate the aerosol-generating article 2. The aerosol-generating device 1 may further include a heat transfer tube 183s for transferring heat to the aerosol-generating article 2. In addition, the aerosol-generating device 1 may further include a film heater 183h that surrounds the heat transfer tube 183s and generates heat when electricity is applied.

According to another embodiment, the aerosol-generating device 1 may further include an insulating tube 41 for blocking heat emitted from the film heater 183h to the outside. The insulating tube 41 may be spaced apart from the outer surface of the film heater 183h and surround the second heater 183.

According to another embodiment, the aerosol-generating article 2 may include a first segment 2a and a second segment 2b that are sequentially positioned from one end of the aerosol-generating article 2 toward the other end thereof. The first heater 182 may be inserted into a portion of the first segment 2a. The second heater 183 may extend from another portion of the first segment 2a to at least a portion of the second segment 2b.

According to another embodiment, the sensor 130 may be positioned outside the portion of the first segment 2a. The sensor 130 and the second heater 183 may be sequentially placed in an extension direction of the aerosol-generating article 2.

According to another embodiment, the first heater 182 may include first lower heating portions 182a and 182b that are partitioned to correspond to a portion of the aerosol-generating article 2. The aerosol-generating device 1 may further include a controller 12 for independently controlling the first lower heating portions 182a and 182b. Based on a signal generated from the sensor 130 according to the characteristics of the aerosol-generating article 2, at least some of the first lower heating portions 182a and 182b may be controlled by the controller 12 to generate heat.

According to another embodiment, the second heater 183 may include second lower heating portions 183a, 183b, and 183c that are partitioned to correspond to another portion of the aerosol-generating article 2. The aerosol-generating device 1 may further include a controller 12 for independently controlling the second lower heating portions 183a, 183b, and 183c. Based on a signal generated from the sensor 130 according to the characteristics of the aerosol-generating article 2, at least some of the second lower heating portions 183a, 183b, and 183c may be controlled by the controller 12 to generate heat.

According to another embodiment, the first heater 182 may include first lower heating portions 182a and 182b partitioned to correspond to a portion of the aerosol-generating article 2, the second heater 183 may include second lower heating portions 183a, 183b, and 183c partitioned to correspond to another portion of the aerosol-generating article 2, and the aerosol-generating device 1 may further include a controller 12 for independently controlling the first lower heating portions 182a and 182b and the second lower heating portions 183a, 183b, and 183c. Based on a signal generated from the sensor 130 according to the characteristics of the aerosol-generating article 2, at least some of the first lower heating portions 182a and 182b and at least some of the second lower heating portions 183a, 183b, and 183c may be controlled by the controller 12 to generate heat.

The aerosol-generating device according to the embodiments described above includes a first heater inserted into a portion of the aerosol-generating device to heat the interior of the aerosol-generating article and a second heater positioned outside another portion of the aerosol-generating article to heat the exterior of the aerosol-generating article, and thus, various regions of the aerosol-generating article may be effectively heated.

In addition, because the heating operations of the first heater and the second heater may be controlled in response to the type of the aerosol-generating article based on a signal from the sensor, various types of aerosol-generating articles may be effectively heated.

In addition, because the sensor is placed in a different area from the area where the second heater is placed, the influence of the heat generated from the second heater on the sensor may be reduced, thereby improving the operational reliability and durability of the sensor.

Effects of the present disclosure are not limited to the above effects, and effects that are not mentioned could be clearly understood by one of ordinary skill in the art from the present specification and the attached drawings.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

What is claimed is:

1. An aerosol-generating device for generating an aerosol by heating an aerosol-generating article, the aerosol-generating device comprising:
a first heater configured to generate heat inside the aerosol-generating article;
a second heater configured to generate heat outside the aerosol-generating article; and
a sensor configured to detect the aerosol-generating article and generate a signal, the sensor being placed to correspond to the first heater in a different area from an area where the second heater is placed outside the aerosol-generating article.

2. The aerosol-generating device of claim 1, wherein at least one of the first heater and the second heater is further configured to generate heat when electricity is applied.

3. The aerosol-generating device of claim 1, further comprising an induction coil configured to generate an alternating magnetic field when electricity is applied,
wherein at least one of the first heater and the second heater is further configured to generate heat by the alternating magnetic field of the induction coil.

4. The aerosol-generating device of claim 1, wherein the second heater has a tubular shape for accommodating the aerosol-generating article and the first heater is insertable into one end of the aerosol-generating article accommodated in the second heater,
the aerosol-generating device further comprising a first support supporting the first heater, a second support supporting one end of the second heater, and an air supply port formed between the first support and the second support,
wherein air introduced from the outside is supplied to the one end of the aerosol-generating article through the air supply port.

5. The aerosol-generating device of claim 4, wherein the second support extends in a circumferential direction of the one end of the second heater to surround the first support, and the air supply port is formed by an inner wall of the second support facing the first support and an outer wall of the first support.

6. The aerosol-generating device of claim 4, further comprising:
an introduction tube allowing external air to be introduced into an interior of the aerosol-generating device; and
a sealing portion placed between the introduction tube and the air supply port to allow air in the introduction tube to flow into the air supply port,
wherein at least one of the first support and the second support is sealed by the sealing portion.

7. The aerosol-generating device of claim 6, wherein the second heater extends in one direction, the introduction tube extends in the one direction, and external air introduced into the interior of the aerosol-generating device by the introduction tube flows along a flow path within the introduction tube separated from an outer surface of the second heater.

8. The aerosol-generating device of claim 4, wherein the air supply port comprises an expansion portion in which at least a portion of the air supply port expands in size toward the one end of the aerosol-generating article.

9. The aerosol-generating device of claim 1, wherein the second heater comprises:
a heat transfer tube capable of accommodating the aerosol-generating article and configured to transfer heat to the aerosol-generating article; and
a film heater surrounding the heat transfer tube and configured to generate heat when electricity is applied.

10. The aerosol-generating device of claim 9, further comprising an insulating tube spaced apart from the outer surface of the film heater and placed to surround the second heater to block heat emitted from the film heater to the outside.

11. The aerosol-generating device of claim 1, wherein the aerosol-generating article comprises a first segment and a second segment sequentially positioned from one end of the aerosol-generating article toward the other end thereof,
wherein the first heater is further configured to be insertable into a portion of the first segment, and the second heater extends from another portion of the first segment to at least a portion of the second segment.

12. The aerosol-generating device of claim 11, wherein the sensor is positioned outside the portion of the first segment, and the sensor and the second heater are sequentially placed in an extension direction of the aerosol-generating article.

13. The aerosol-generating device of claim 1, wherein the first heater comprises first lower heating portions partitioned to correspond to a portion of the aerosol-generating article,
the aerosol-generating device further comprising a controller configured to independently controlling the first lower heating portions,
wherein, based on a signal generated from the sensor according to characteristics of the aerosol-generating article, at least some of the first lower heating portions are controlled by the controller to generate heat.

14. The aerosol-generating device of claim 1, wherein the second heater comprises second lower heating portions partitioned to correspond to another portion of the aerosol-generating article,
the aerosol-generating device further comprising a controller configured to independently controlling the second lower heating portions,
wherein, based on a signal generated from the sensor according to characteristics of the aerosol-generating article, at least some of the second lower heating portions are controlled by the controller to generate heat.

15. The aerosol-generating device of claim 1, wherein the first heater comprises first lower heating portions partitioned to correspond to a portion of the aerosol-generating article, and the second heater comprises second lower heating portions partitioned to correspond to another portion of the aerosol-generating article,
the aerosol-generating device further comprising a controller configured to independently control the first lower heating portions and the second lower heating portions,
wherein, based on a signal generated from the sensor according to characteristics of the aerosol-generating article, at least some of the first lower heating portions and at least some of the second lower heating portions are controlled by the controller to generate heat.
